(19) United States
(12) Patent Application Publication
(10) Pub. No.: US 2008/0022412 A1
(43) Pub. Date: Jan. 24, 2008

(54) System and method for TPM key security based on use count

(76) Inventors: David Carroll Challener, Raleigh, NC (US); James Patrick Hoff, Wake Forest, NC (US); David Rivera, Durham, NC (US)

Correspondence Address: ROGITZ & ASSOCIATES, 750 B STREET, SUITE 3120, SAN DIEGO, CA, 92101, US

(21) Appl. No.: 11/477,062

(22) Filed: Jun. 28, 2006

(51) Int. Cl. H04L 9/32

(52) U.S. Cl. 726/27

(57) ABSTRACT

A trusted platform module (TPM) key is assigned a numerical limit for the number of times the key can be used, and once the key has been used the assigned number of times, it is rendered unusable.

### FIELD OF THE INVENTION

The present invention relates generally to maintaining the security of trusted platform module (TPM) encryption keys.

### BACKGROUND OF THE INVENTION

Trust has become an important issue for e-commerce and other applications, particularly for mobile computing devices such as notebook computers. Specifically, as the mobility of the computing platform increases, it becomes susceptible to theft, with stolen data often representing a bigger loss than the hardware itself, because the data can include, e.g., user identity information, credit card information, and so on.

With this in mind, the Trusted Computing Group (TCG) has been formed to develop a specification for a trusted computing platform. Using a hardware security module (actually, a microcontroller) known as the Trusted Platform Module (TPM) that is soldered to the motherboard of the computing platform, the TCG establishes what can be thought of as a platform root of trust that uniquely identifies a particular platform and that provides various cryptographic capabilities including hardware-protected storage, digital certificates, IKE (Internet Key Exchange), PKI (Public Key Infrastructure), and so on. Essentially, to overcome the vulnerability of storing encryption keys, authentication certificates, and the like on a hard disk drive, which might be removed or otherwise accessed or tampered with by unauthorized people, encryption keys, certificates, and other sensitive data is stored on the secure TPM.

The various TPM keys are unique to the TPM. The keys are either generated at manufacturing time outside the TPM and then sent (“squirted”) to the TPM for storage, or the keys are generated within the TPM itself. The keys can be used to in turn encrypt other keys for various purposes, thereby extending the trust boundary as desired..

With the above in mind, the present invention recognizes that maintaining the security of TPM keys is important. As understood herein, however, once TPM keys are generated, they may be used repeatedly without limit as long as proper authorization is provided, meaning that in the unlikely but nonetheless potential event that they become compromised, they can be used by an unauthorized person or computer. As still further understood herein, limiting the use of keys by tying them to certificates that have expiration dates has the drawback that the keys may still be used as often as desired before certificate expiration, and moreover, even after certificate expiration the keys may remain valid, raising the potential for use of the keys outside of certificate usage. With these critical observations in mind, the invention herein is provided.

### SUMMARY OF THE INVENTION

A method includes generating a key and, using a trusted platform module (TPM) of a computer, storing a representation of the key (such as the key itself and/or a hash thereof) and a use count associated with the key. In response to a request for use of the key, it is determined whether the use count is greater than zero, and if so use of the key is permitted and the use count decremented, but if not use of the key is denied.

In some implementations the TPM is a hardware module soldered to a motherboard of the computer, and the computer includes a main processor external to the TPM. The TPM includes a TPM controller. The TPM may generate the key, and may be used to hash a key blob and store the key blob with the use count.

The use count can be initialized at unity to permit only one use of the key. Such a one-time use key may be appropriate for, e.g., encrypting a password for retrieval if the password is forgotten. In another illustrative use, the use count is initialized at a value equalling a permitted number of trial uses of a software program or multimedia program, and at least a portion of the software program or multimedia program requires the key to permit use of the program, so that a desired limited number of uses is enforced. If desired, an authorized user can be permitted to alter the use count and/or to remove the key from the TPM.

In another aspect, a computing device has a computer processor and a security module including a module controller and a module storage containing one or more keys with associated counts that represent a number of remaining uses of the respective keys.

In still another aspect, a computer has a computer processor supported on a motherboard and a security module associated with the motherboard and communicating with the computer processor. Means are provided for associating a key and a respective use count in the module. Also, means are provided for satisfying a request involving the key only if the use count is not a predetermined value.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present architecture;

FIG. 2 is a flow chart of non-limiting key generation logic; and

FIG. 3 is a flow chart of non-limiting key use logic.

### DETAILED DESCRIPTION OF THE PREFERRED EMBODIMENT

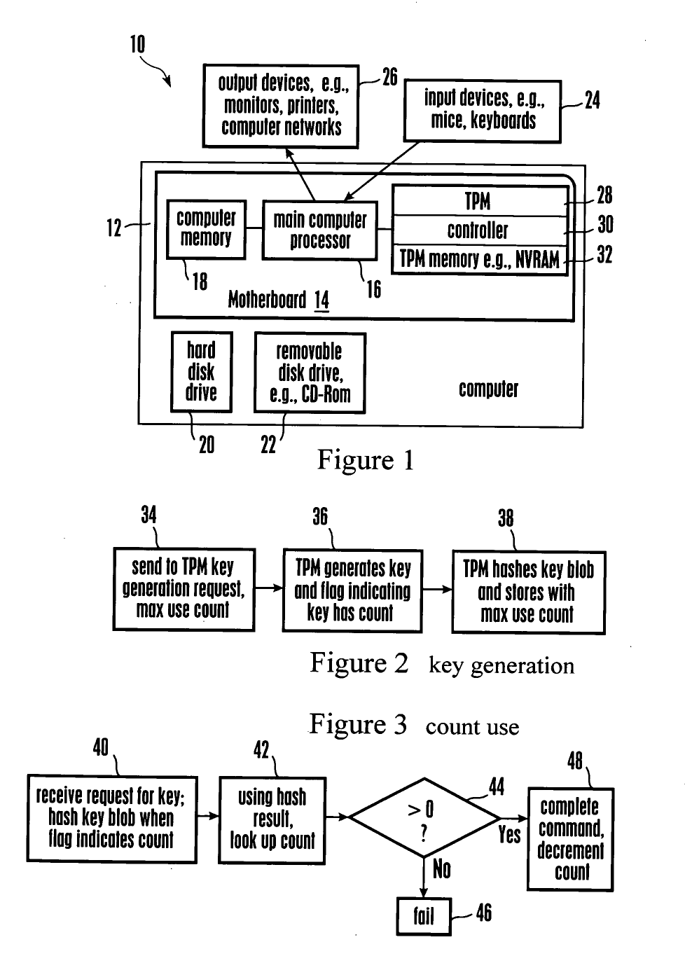

Referring initially to FIG. 1, a computing system is shown, generally designated 10, that includes a customer computer 12. The computer 12 can be any suitable computer, e.g., a personal computer or larger, a laptop computer, a notebook computer or smaller, etc.

As shown in FIG. 1, the preferred non-limiting customer computer 12 includes a motherboard 14 on which is mounted at least one main central processing unit (CPU) 16 that can communicate with a solid state memory 18 on the motherboard 14. The memory 18 can contain basic input/output system (BIOS) instructions useful for booting the computer 12 at start up. Additionally, other storage can be provided external to the motherboard 14, e.g., a hard disk drive 20 and a removable drive 22 such as but not limited to a CD-ROM drive, removable memory stick drive, etc. Moreover, the CPU 16 can communicate with external devices including input devices 24 such as keyboards, mice, voice recognition devices, etc. and output devices 26 such as monitors, printers, computer networks, etc. in accordance with principles known in the art.

As intended by the present invention, the customer computer 12 can be rendered into a trusted device by the user. To this end, a security module such as a trusted platform module (TPM) 28 is provided on the motherboard 14. The presently preferred non-limiting TPM 28 is a hardware module that is soldered or otherwise affixed to the motherboard 14. The TPM 28 can include a TPM controller 30 and TPM memory 32 such as non-volatile random access memory that can store various TPM keys, including storage keys, endorsement keys, “pretty good encryption” public/private keys known as RSA keys, and so on.

FIG. 2 shows the logic of the present invention. Commencing at block 34, a key such as an RSA key is generated by, e.g., sending to the TPM 28 a key generation request along with an initial (“max”) use value. At block 36, the TPM generates the key in accordance with TPM key generation principles known in the art, e.g., by means of a random number using public key/private key generation principles known in the art. It is to be understood that alternatively the key may be generated outside the TPM and then “squirted” to the TPM at the time of manufacture, i.e., the key may be sent to the TPM at block 34 in lieu of a generation request. In the context of public/private keys, after key generation the computer 12 typically may be shipped, vended, or otherwise provided to the customer, it being understood that present principles also apply to other TPM keys.

As indicated in FIG. 2 at block 36, based on a use count being received in the request at block 34, the TPM controller 30 also preferably associates a flag with the key indicating that the key has limited uses. Also, the TPM controller 30 preferably generates limited use keys as non-migratable keys to enforce the use limit within the TPM.

Proceeding to block 38, in some implementations the TPM can hash the key blob and store it in a table in, e.g., TPM memory 32 along with the use count, which is initialized to the “max” value received in the request at block 34. It is to be understood that the table storing the use count and the hash of the key blob can be in addition to the pre-hash key value itself, or the pre-hash key value may be stored with the use count without use of a key blob hash.

FIG. 3 illustrates how the above data structures can be used. Commencing at block 40, a request from the processor 16 for the key (equivalently, for the TPM 28 to use the key in some specified way) is received by the TPM. The TPM observes the flag associated with the key, indicating that the key is a limited use key, and accordingly hashes the key blob and proceeds to block 42 to enter the above-mentioned table using the hash result as entering argument to retrieve the use count associated with the key.

The logic next flows to decision diamond 44, where it is determined whether the use count is or is not a predetermined value. In the example shown, it is determined at decision diamond 44 whether the use count is greater than zero. If not, “fail” is returned at block 46 in response to the request, but otherwise the request is satisfied at block 48 and the value of the use count in memory is decremented by unity. Other methods for rendering the key unusable when the use count falls to zero may be used in addition to or in lieu of a programmatic limit, e.g., the key can be deleted from TPM memory 32 when the use count is found to be zero.

With the above disclosure in mind, the present facilitates several uses and advantages. The use count can be initialized at unity to permit only one use of the key. Such a single use key may be used, e.g., to encrypt a TPM password. If the password is forgotten, TPM administrators can provide a user with authorization to use the key to recover the TPM password, which then is changed, with the TPM key being rendered useless thereafter.

In another use, the use count can be initialized at a value equalling a permitted number of trial uses of a software program or multimedia program such as a video or music file. All or part of the program (e.g., a dynamic link library (DLL)) is encrypted and the encryption key is wrapped to the public key of a limited use public/private key pair. Each time the program is executed, the limited use key is accessed to unbind the encryption key, so that once the maximum number of uses has been reached, no further use of the program is possible.

Special owner-authorized commands may also be provided, including the ability to reset or otherwise alter the use count, remove a key entry from the table, clear the table completely, and report the content of the table.

It may now be appreciated that the number of times a TPM key can be used can be limited using present principles. Thus, in a secure environment keys used to identify users may be limited to, e.g., one hundred uses before a new key must be generated to help limit exposure should a key be compromised. Similarly, a key can be rendered useless if a user leaves an organization or otherwise has no further need to know information protected by a key by setting the use count of the key to zero or by deleting the key from the table in the TPM memory 32.

While the particular SYSTEM AND METHOD FOR TPM KEY SECURITY BASED ON USE COUNT is herein shown and described in detail, it is to be understood that the subject matter which is encompassed by the present invention is limited only by the claims.

1. A method comprising the acts of:
generating at least one key;
using a trusted platform module (TPM) of a computer, storing a representation of the key and a use count associated with the key; and
in response to a request for use of the key, determining a value of whether the use count and based on the value determining whether to permit use of the key.

2. The method of claim 1, wherein the TPM is a hardware module soldered to a motherboard of the computer, and the computer includes a main processor external to the TPM, the TPM including a TPM controller.

3. The method of claim 1, wherein the TPM generates the key.

4. The method of claim 1, comprising using the TPM to hash a key blob and storing the key blob with the use count.

5. The method of claim 1, wherein the use count is initialized at unity to permit only one use of the key.

6. The method of claim 5, wherein the key is used to encrypt a password.

7. The method of claim 1, wherein the use count is initialized at a value equalling a permitted number of trial uses of at least one of: a software program or multimedia program, and at least a portion of the software program or multimedia program requires the key to permit use of the program.

8. The method of claim 1, comprising permitting an authorized user to alter the use count.

9. The method of claim 1, comprising permitting an authorized user to remove the key from the TPM.

10. A computing device, comprising:
at least one computer processor; and
at least one security module including at least one module controller and at least one module storage containing at least one key and at least one count associated with the key for determining whether to permit use of the key.

11. The device of claim 10, wherein the security module is a to platform module (TPM) soldered to a motherboard of the computing device.

12. The device of claim 10 wherein the processor is operatively connected to the security module for requesting use of the key.

13. The device of claim 12, wherein in response to a request for use of the key, the module determines whether die count is greater than zero, and if so permits use of the key and decrements the count, and otherwise does not permit use of the key.

14. The device of claim 10, wherein the nodule generates the key.

15. The device of claim 10, wherein the count is initialized at unity to permit only one use of the key.

16. The device of claim 15, wherein the key is used to encrypt a password.

17. The device of claim 10, wherein the count is initialized at a value equalling a permitted number of trial uses of at least one of: a software program or multimedia program, and at least a portion of the software program or multimedia program requires the key to permit use of the program.

18. A computer comprising:
at least one computer processor supported on a motherboard;
at least one security module associated with the motherboard and communicating with the computer processor;
means for associating at least one key with a respective use count in the module; and
means for satisfying a request involving the key only if the use count is not a predetermined value.

19. The computer of claim 18, wherein the predetermined value is zero.

20. The computer of claim 18, comprising means for hashing a key blob and storing the key blob with the use count.
